(19) United States
(12) Patent Application Publication
(10) Pub. No.: US 2014/0030476 A1
(43) Pub. Date: Jan. 30, 2014

(54) POLYMER COMPOSITE STRUCTURE AND METHOD

(71) Applicant: Kian Sheikh-Bahaie, British Columbia (CA)

(72) Inventor: Kian Sheikh-Bahaie, British Columbia (CA)

(21) Appl. No.: 13/948,372

(22) Filed: Jul. 23, 2013

Related U.S. Application Data
(60) Provisional application No. 61/674,944, filed on Jul. 24, 2012.

(51) Int. Cl. B32B 7/04; B32B 3/12; B32B 3/30

(52) U.S. Cl. CPC B32B 7/045; B32B 3/30; B32B 3/12
USPC 428/116; 428/172; 428/167; 156/272.8

(57) ABSTRACT

An assembly including a first component having a first side and a second side opposite the first side, the first side having at least one bonding structure extending therefrom and spaced from an outer perimeter of the first component, and a second component having a first side and a second side opposite the first side, the second component thermally bonded to the first component along at least one interior interface including said bonding structure, said interface fully enclosed between the first and second components. At least a portion of at least one of the first or second components is laser transparent to allow passage of laser energy through said laser transparent portion to a laser opaque portion of the interface, said laser opaque portion configured to absorb laser energy to facilitate bonding.

### CROSS REFERENCE TO RELATED PATENTS AND APPLICATIONS

This application claims priority to and the benefit of the filing date of U.S. Provisional Patent Application Ser. No. 61/674,944, filed Jul. 24, 2012, which application is hereby incorporated by reference.

### BACKGROUND

The present disclosure relates generally to components having a high strength-to-weight ratio and processes for making the same. The disclosure finds particular application in connection with plastic components.

The disclosure is applicable to a wide range of applications in different industries, especially applications which currently use light metal alloys and carbon fiber composites. Composite materials and light alloys metals are used in a variety of applications. High stiffness to weight ratio is one of the most attractive properties of these materials/composites. This high ratio leads to lighter products that can handle heavier loading condition compared to conventional materials with lower ratios (like, for example, Iron).

Certain disadvantages of said materials can limit their use in industry significantly. For example, light alloy metals use rare earth metals that are expensive, generally hard to process and can require extensive protection against corrosive environments. Carbon fiber composites (CFC) and glass fiber composites (GFC) are not cheap either. Labor intensive manufacturing process, use of harsh chemicals and limited flexibility in product design/manufacturing limits their use.

Recycling is also an important factor in material selection for industry. Recycling of light alloy metals generally consumes high levels of energy. On the other hand, carbon fiber and glass fiber composites are rarely recyclable because of the chemicals used during their manufacturing process. Most of products made by GFC (glass fiber composites) and CFC (carbon fiber composites) end up in landfills after their service life expires.

To address these challenges, various approaches have been developed during recent years. Industry has selected carbon fiber composite (CFC) as an ideal candidate and has put forth a lot of effort to reduce its manufacturing cost. CFC still carries its series of disadvantages including limited flexibility in design and that is not generally recyclable, but has been considered as the most attractive solution to reduce components weight in the products. Current increase in energy cost (oil prices) is the main motive behind this approach.

### SUMMARY

The limitations of the prior art identified above have been identified by the inventor and the present disclosure sets forth components and methods for making the same that include one or more of the following features:
1) Deliver high stiffness to weight ratio.
2) Easy to manufacture, and compatible with high volume manufacturing setup.
3) Deliver maximum design flexibility.
4) Easy to recycle with minimal energy.
5) Low capital investment for manufacturing setup/equipments.
6) Minimal environmental impact during its lifecycle.
7) Capable of handling harsh environmental conditions without extra protection (like coating, plating, and paint).
8) Lower material/product cost compared to current solutions.

In accordance with one aspect, an assembly comprises a first component having a first side and a second side opposite the first side, the first side having at least one bonding structure extending therefrom and spaced from an outer perimeter of the first component, and a second component having a first side and a second side opposite the first side, the second component thermally bonded to the first component along at least one interior interface including said bonding structure, said interface fully enclosed between the first and second components. At least a portion of at least one of the first or second components is laser transparent to allow passage of laser energy through said laser transparent portion to a laser opaque portion of the interface, said laser opaque portion configured to absorb laser energy to facilitate bonding.

The at least one interface can include a plurality of bonding structures extending from at least one of the first or second components. The at least one interface can be between adjacent bonding structures extending respectively from the first and second components. The plurality of bonding structures can include one or more ribs having a shape. The shape can include at least one of a straight shape, a curved shaped, a closed shape, a honeycomb shape, a diamond shape, or a rectangular shape. At least one of the first or second components can be comprised of a material including at least one of thermoplastic polymers or fiber reinforced thermoplastic polymers. The materials can include polymers such as PA, PPA, PBT, and all of the thermoplastic plastics and thermoplastic elastomeric polymers.

In accordance with another aspect of the present disclosure, an assembly comprises a first part and a second part bonded to the first part, the assembly having an interior chamber and an exterior shell surrounding said chamber, the first part and second part being bonded together along an interface within said chamber, a portion of the exterior shell being laser transparent, and the interface being formed between a laser transparent part of the first part and a laser opaque portion of the second part.

The interface can include a plurality of bonding structures extending from at least one of the first or second components. The plurality of bonding structures can include one or more ribs having a shape. The shape can include at least one of a straight shape, a curved shaped, a closed shape, a honeycomb shape, a diamond shape, or a rectangular shape. At least one of the first or second components can be comprised of a material including at least one of thermoplastic polymers or fiber reinforced thermoplastic polymers. The materials can include polymers such as PA, PPA, PBT, and all of the thermoplastic plastics and thermoplastic elastomeric polymers.

In accordance with another aspect, a method of making an assembly having at least two components bonded together comprises the steps of placing a first component in contact with a second component to form an interface, the first component having a first side and a second side opposite the first side, the first side having at least one bonding structure extending therefrom and spaced from an outer perimeter of the first component, and securing the first component to the second component along an interface including the bonding structure, said interface fully enclosed between the first and second components. The securing includes passing a laser through a laser transparent portion of at least one of the first or second components to a laser opaque portion of at least one of the first or second components, whereby laser energy passing through the laser transparent portion and absorbed by the laser opaque portion heats the laser opaque portion to weld the first and second components together along an interface therebetween.

The method can further include forming the first component having the bonding structure, wherein the forming includes selecting at least one design parameter, and determining at least one of a dimension of the first component, or a location or a dimension of the at least one bonding structure based at least in part on the selected design parameter. Selecting the at least one design parameter can include selecting at least one of the following design parameters: environmental protection, impact protection, thermal insulation, acoustic insulation, thermal management, aerodynamic performance, weight reduction, enhanced resonance frequency, defined fracture path, low production cost, low tooling cost, recyclable, and/or short development cycle.

### BRIEF DESCRIPTION OF THE DRAWINGS

FIG. 1 is a perspective view of an exemplary component in accordance with the present disclosure;

FIG. 2, is a perspective view of another exemplary component in accordance with the present disclosure;

FIG. 3 is a perspective cross-sectional view of the component of FIG. 2;

FIG. 4 is a perspective view of another exemplary component in accordance with the present disclosure;

FIG. 5 is a perspective cross-sectional view of the component of FIG. 4;

FIG. 6 is a perspective view of yet another exemplary component in accordance with the present disclosure;

FIG. 7 is a perspective view of the component of FIG. 6 with a portion thereof removed;

FIG. 8 is still another exemplary component in accordance with the present disclosure;

FIG. 9 is a perspective cross-sectional view of the component of FIG. 8;

FIG. 10 is an exploded view of an assembly in accordance with the present disclosure;

FIG. 11 is a cross-sectional view of the assembly of FIG. 10; and

FIG. 12 is an exploded view of another assembly in accordance with the present disclosure.

### DETAILED DESCRIPTION

A composite material is made of a set of different materials having generally different mechanical properties joined together to provide optimum mechanical properties for a targeted application. One goal of such structure is to gain high stiffness to weight ratio for any given application. Different layers of materials are joined together using a carrier such as a polymer or adhesive.

In this disclosure, a composite structure includes a series of components, mainly made of super structural polymers, for example, as a main carrier. These carriers can be made/formed using conventional polymer forming techniques (injection molding, extrusion, forming, etc.) and joined together using a welding technique, such as a polymer laser welding technique. Location and distribution of the weld joints can predict the performance of the product under different loading conditions. In addition, internal structure of each part further enhances the load carrying capabilities where it is needed the most. Overall, an integrated structure with specific rib/weld/component configuration is the outcome of the process, which forms a solid material with enhanced functionality.

In one exemplary configuration, geometric shapes, such as a honeycomb structure, can be provided on one or both parts. When joined together through the welding process disclosed herein, the honeycomb structure can provide increased structural rigidity to the component, thereby increasing the weight to stiffness ratio of the product. Ribs/welds can also be removed or omitted in certain areas to provide a controlled path for fracture when a load limit is reached. In another example, straight ribs in parallel are used to increase the stiffness in certain directions while maintaining the flex in other directions. Flexibility in the design of the ribs and the weld paths provides virtually unlimited flexibility for the designer to move the material around as needed to enhance the product functionality/performance by placing the ribs/welds where desired to produce a given structural property.

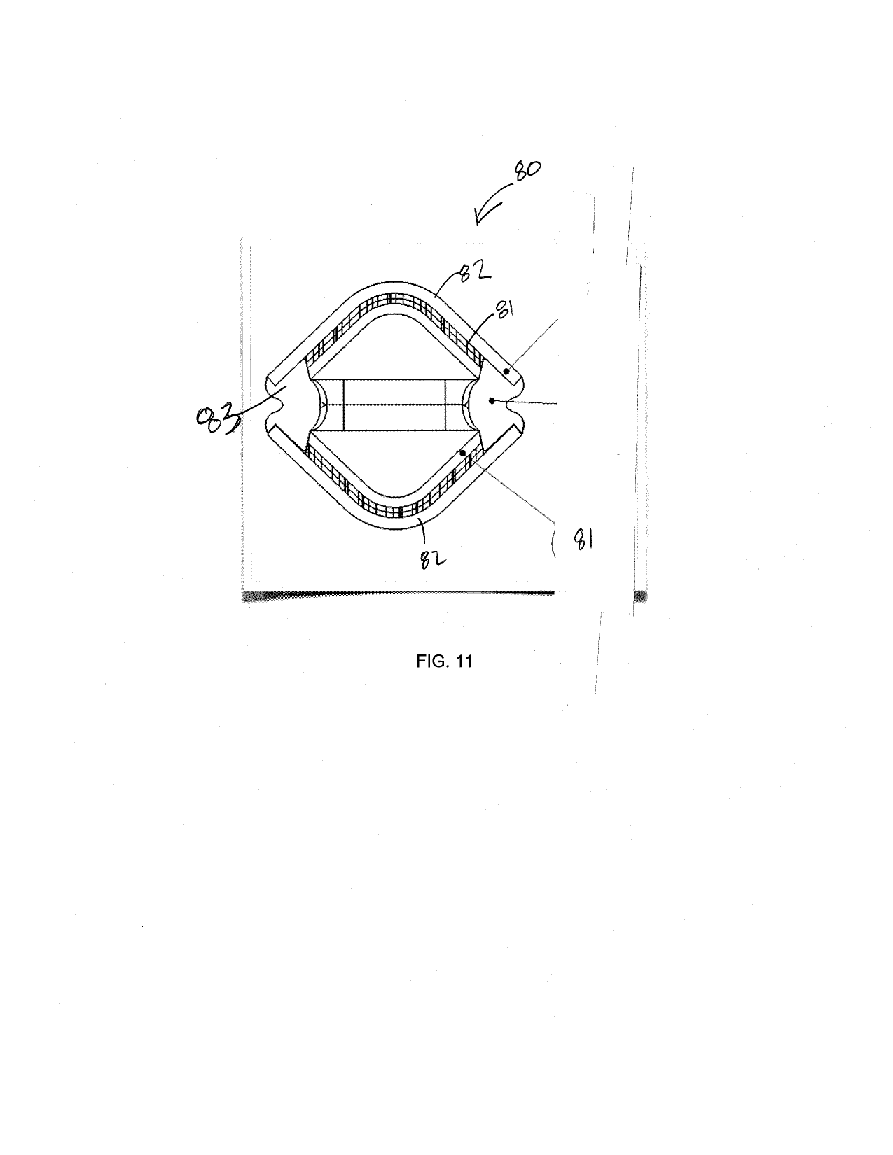

One product made using this technique comprises at least two formed polymers. Some components can have more than two polymer components in addition to a series of supplementary materials/components (metal inserts, motors, harnesses, etc.) that may be supported inside or outside the component after welding takes place. Support geometry can be created inside the component for anchoring of the said supplementary components inside the unit to further enhance their functionality. As will be seen below, FIG. 11 shows an example of a support geometry: Reference Numeral 2 is a metal pipe supported by a series of special geometry ribs (Reference numerals 1 and 3). Components like wire harnesses, electric motors, beams, switches, sensors, hinges, hoses, valves, actuators, or any other item which may be a part of the final product assembly can be inserted inside to form a more robust assembly/structure. The support geometries for supporting such component(s) depends on, among other things, the feature and its function. Some examples include screw bosses, ultrasonic welding, snap fits, slots, locating pins, over-molded supports, friction fits, locating walls and ribs.

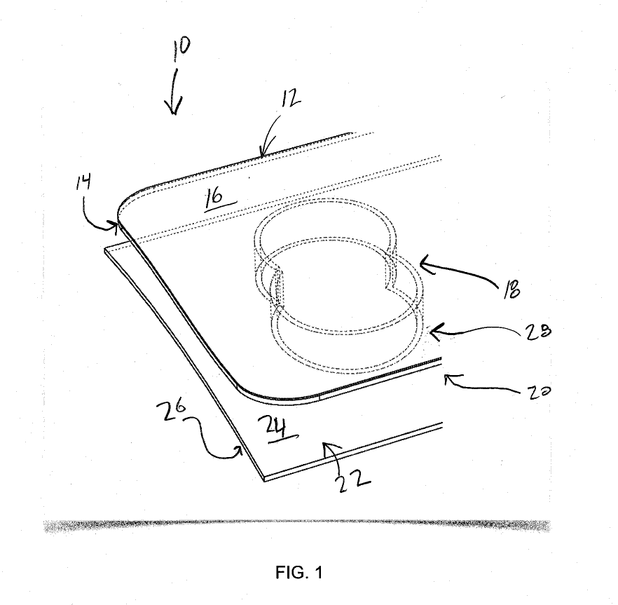

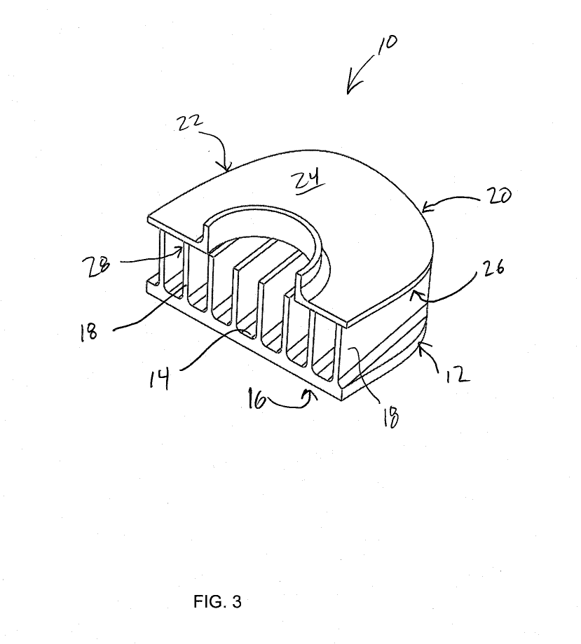

With reference to FIGS. 1-10, and initially to FIG. 1, a component assembly is illustrated and identified generally by reference numeral 10. It will be appreciated that throughout the exemplary embodiments of FIGS. 1-10, like reference numerals refer to like parts. The component assembly 10 of FIG. 1 includes a first component 12 having a first side 14 and a second side 16 opposite the first side 14. The first side 14 has at least one bonding structure 18 extending therefrom and spaced from an outer perimeter 20 of the first component 12. A second component 22 has a first side 24 and a second side 26 opposite the first side 24. The second component 22 is bonded to the first component 12 along at least one interior interface identified generally by reference numeral 28. The interface 28 includes the bonding structure 18 and is enclosed between the first and second components 12 and 22. At least a portion of at least one of the first or second components 12 or 22 is laser transparent to allow passage of laser energy through the laser transparent portion to a laser opaque portion of the interface. The laser opaque portion is configured to absorb laser energy to facilitate bonding of the first and second components 12 and 22.

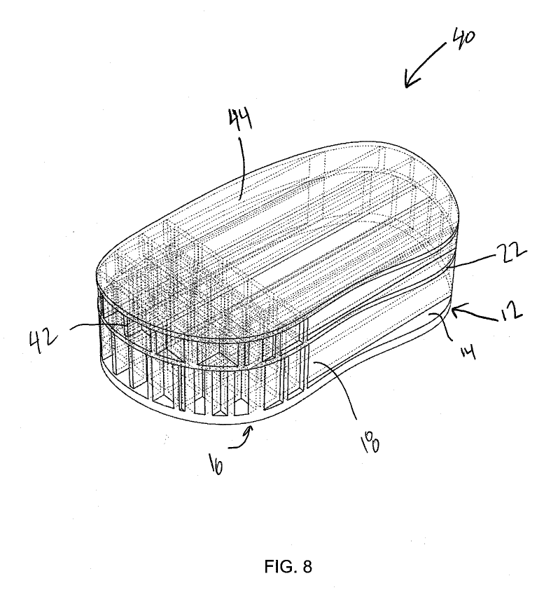

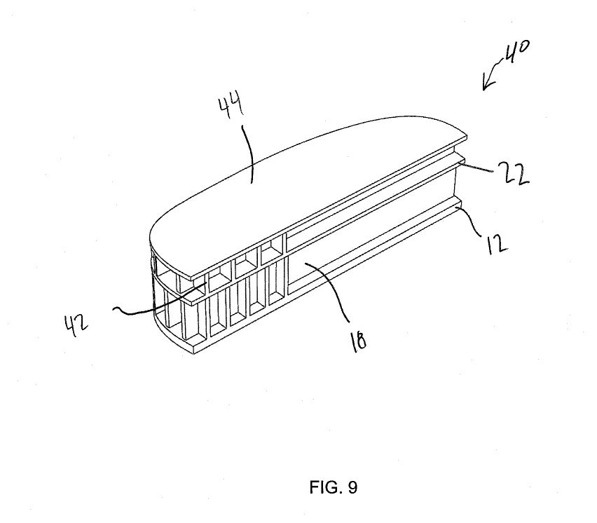

The embodiments illustrated in FIGS. 1-9 each are of similar construction and include one or more features that enhance performance of the component. Accordingly, the description above relating to FIG. 1 is applicable to the embodiments of FIGS. 1-9. In addition, the embodiment illustrated in FIGS. 8 and 9 includes a component assembly 40 having an additional component 42 having structures 44 formed therewith. The structures 44 can be bonded to the other components in the same manner as described above. In this embodiment, it will be appreciated that the first, second and third components are assembled in the same manner and the first and second components described in connection with FIG. 1. Of course, additional components could be assembled, and virtually any number of components can comprise a component assembly in accordance with the present disclosure.

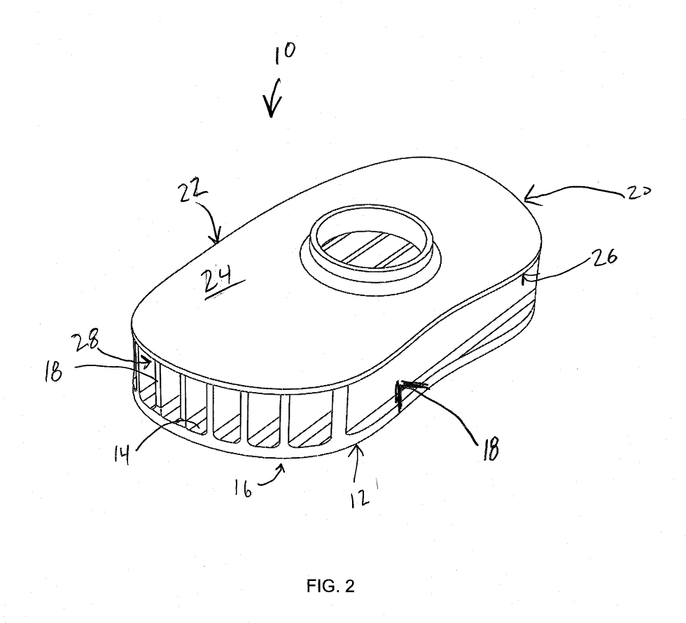

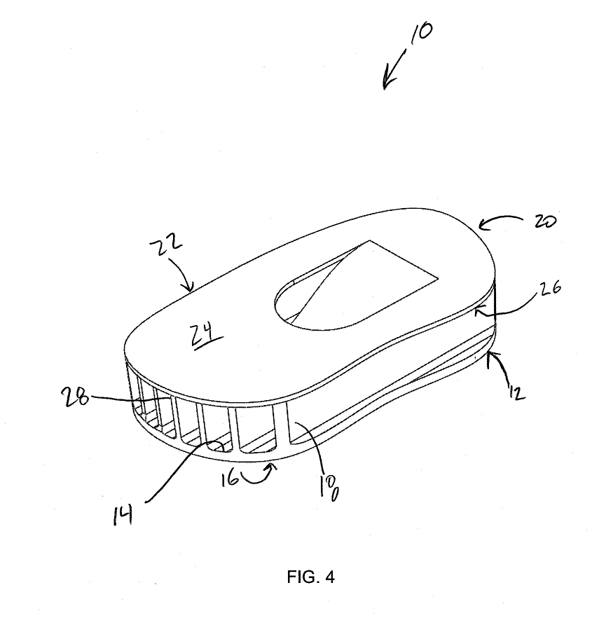

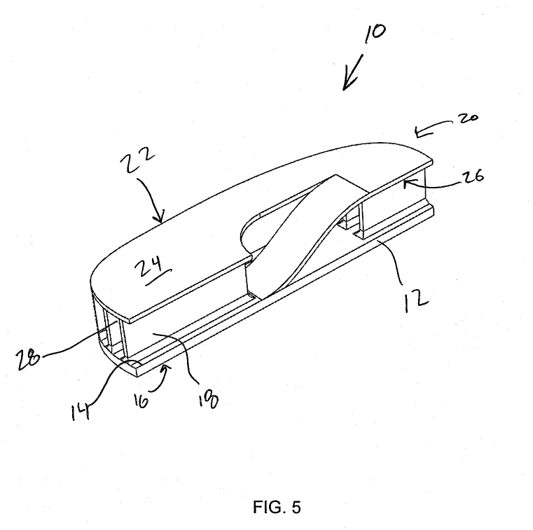

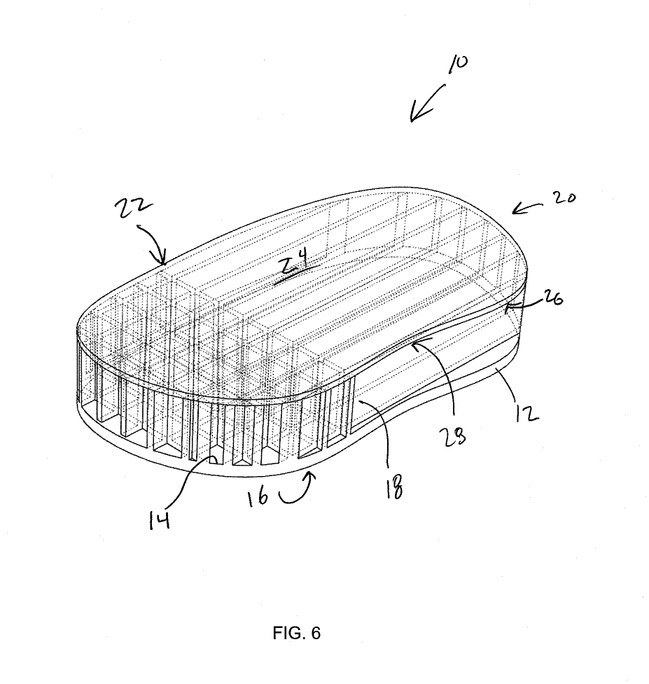

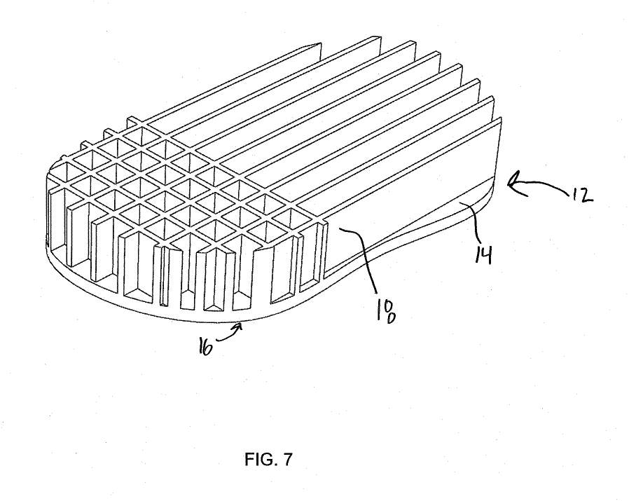

Special features with specific geometry can be built/integrated into the unit. These features are part of the structure and are made of the laser weld-able polymers. One goal is to enhance the functionality of the product while minimizing its complexity. Examples are:
1. High Stiffness to Weight Ratio: One advantage of this disclosure is to provide high levels of stiffness to weigh ratio. While this need is satisfied other benefits can also be gained as listed below.
2. Thermal insulation: thermal insulating material can be added inside the assembly to block the heat transfer in required area(s) (see FIG. 1, for example). As an alternative (to save weight and material cost) a series of cavities can be designed inside the unit and be welded to create thermal barrier. In more extreme cases pockets can be welded under vacuum to form a vacuum chamber for maximum thermal insulation without any added cost of extra insulation. As an example, the structure of a refrigerator can be made using this technique to from chambers in the side walls where needed to reach maximum thermal insulation while reducing the product weight/cost. In another example, side walls of a clothes dryer machine can be made using similar technique to prevent heat transfer to the environment, increasing the unit's efficiency, without any added weight. Another example is an underbody panel of a vehicle that can be designed to minimize the heat transfer from road/power train/exhaust to the cabin of the vehicle.
3. Acoustic insulation: Acoustic insulation can be achieved similar to the way explained for thermal insulation. Acoustic insulating material can be added inside the assembly to block the sound transfer in required area(s) (see FIG. 1, for example). As an alternative (to save weight and material cost) a series of cavities can be designed inside the unit and be welded to create sound barrier. In more extreme cases pockets can be welded under vacuum to form a vacuum chamber for maximum acoustic insulation without any added cost of extra insulation. As an example, the structure of a passenger car hood can be made using this technique to from chambers in the side walls where needed to reach maximum acoustic insulation while reducing the product weight/cost. In another example, passenger car doors can be made using similar technique to prevent sound transfer to the cabin, reducing the noise inside the car, without any added weight. Another example is an underbody panel of a vehicle that can be designed to minimize the sound transfer from road/power train/exhaust to the cabin of the vehicle.
4. Thermal management: extra geometry features can be designed inside the unit to further enhance the thermal conductivity of the unit. Special ducts can be part of the assembly to direct the flow of the air/liquid to the hot spots. In addition special heat sinking elements can be integrated into the assembly or polymer can be coated with materials with higher thermal conductivity in order to further enhance the heat transfer rate. As an example, the case of an electronic device (phone, computer) can have built-in ducts to direct the fluid (air or liquid) to the areas that need to get cooled. This is achieved as layers get welded and form the proper channel for fluid to pass through, maximizing the thermal efficiency without any added cost. (See FIGS. 2-5, for example).
5. Aerodynamic performance: Special features can be added to enhance the aerodynamic performance of the unit when comes in contact with fluids. Examples are directing the flow to cooling elements, creating lift, down force, drag, create turbulent, or prevent turbulent. Special features can be designed with proper stiffness in addition to the proper geometry/location. Such a combination can be achieved as composite forms in layers creating the perfect feature as designer wishes. The outer shell controls the flow of the fluid and the inner structure of laser welded layers and ribs generate the required stiffness to satisfy the function. (See FIGS. 4-5, for example).
6. Resonance frequency: this feature can be managed in the geometry by controlling the stiffness and material density in the assembly as layers take form. As an example, the resonance frequency of passenger car doors is typically important since the doors act as support for speakers of the car audio system too. By making the door entirely from the composite described in this disclosure, special internal ribbing structure can be added to enhance the stiffness of the door in certain directions to prevent it from resonating as the speaker activates within its frequency range. In this regard, a designer is freely flexible to use virtually any kind of rib as long it is manufacturable and delivers the designed function. Examples are straight, curved, polygonal, and/or circular rib forms. Ribs can be anchored to the forming layers. This is an advantage of the method of the present disclosure wherein the laser welding process facilitated welding of internal components to adjacent layers). This further improves the performance of the added material in the form of ribs, creating a very high value of the “stiffness to weight ratio”. In other words, instead of having a rib supported by only one end, it will be supported at both ends forming a very stiff structure, minimizing the required material. (See FIGS. 6-7, for example).

It will be appreciated that in one embodiment, the ribs are supported by both ends (welded to both ends, or integrated to one, welded to the other one). By integrated, it is meant that the lower part in FIGS. 6-7 is one part coming out of a mold having the ribs formed integral therewith. This makes it possible to have ribs with support at both ends to the outer shells creating a very robust assembly, so a designer can use less material for the product thereby minimizing the required material to handle a defined loading scenario.
7. Impact resistance: as referenced in resonance frequency, different levels of stiffness can be achieved by controlling the ribbing density and laser welding pattern. Areas that carry most of the load during component service life (for example, a door hinge support of a vehicle door) or areas most vulnerable to impacts (for example, an outer shell of a safety helmet) are prime candidates for such an improvement for a designer. In addition to the polymer, other components can be added to the welded assembly to enhance the impact resistance. Examples are special bars inside the doors made of CF (carbon fiber) or metal. Layers also can distribute the load to a larger area, preventing sudden fracture in the structure. This can prevent flying particles during high speed impacts (in contrast to carbon fiber composites, which may shatter in failure). This can be a desirable feature in safety related applications. (See FIGS. 8-9, for example)
8. Fracture Path: aspects of this disclosure can also be used to create a fracture path for a controlled fracture mechanism when a product is exposed to a certain loading condition. While the density of the ribs and their location dictates the stiffness, their absence can create a path for fracture during a failure event. This can provide a controlled fracture mechanism for the product along a defined path dictated by the construction of the product.

Each of the properties described above can be achieved, for example, by creating a closed shell structure with inter-connected ribs (or other structural features) fused together using a laser welding technique. In initial lab testing to verify the process, a laser welding machine from LIESTER was implemented having a diode laser operating with 140 watts of power. Laser welding is performed by using a series of laser transparent polymers and laser opaque materials. In a basic example, a first component made of a laser transparent material is placed into position with a second component made of a laser opaque material, pressed against each other using a clamping device. Laser energy is passed through the laser transparent polymer of the first component, tracing an interface area between the first and second components. The laser opaque material of the second component blocks the laser passage and the laser energy gets released, thereby melting the laser opaque material. As result the laser transparent material in contact with the laser opaque polymer gets melted too, fusing the first and second components together and creating a bond.

Another alternative would be to make mating surfaces (e.g., the interface) of the first and/or second components “laser opaque” and the rest of both/one of the component(s) transparent to the laser beam. As laser light passes through the transparent portion of either or both the first and second components, hits the interface of the first and second components and releases its energy, melting the area and forming the weld. Special coatings can be used on the mating surfaces to achieve different levels of weld integrity. Examples include coating the interface with a thin layer of material (a thin sheet of laser opaque material in the assembly configured to melt and bond with adjacent structure when exposed to laser energy), metal particles, fiber particles, and special adhesives. Location and distribution of the bond is dictated by design requirements to achieve optimum mechanical performance.

It is often assumed that the weld is one of the weakest points in the structure. However, considering the efficiency and ease of process in laser welding of the inside ribs/walls in addition to the perimeter of a given assembly, weld seams can be distributed to a wide area, eliminating the apparent weakness associated to the weld.

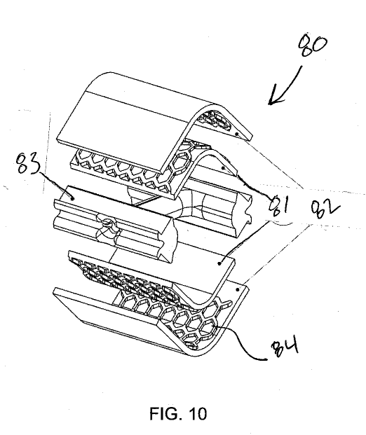

FIG. 10 illustrates an exploded view of a five layer assembly 80, which is a portion of a frame of a tennis racket. Part 81 and part 83 are opaque to laser light and part 82 is transparent. During welding, a laser beam passes through part 82 melting the interface between opaque layers 81 and 83. During the process the entire surface area of the parts 81 and 82 get welded to each other forming a solid shell. This includes the perimeter of the parts and entire contact area (interface) in between, which includes the top surface area of the hex shaped ribs 84. Parts 82 and 83 also get welded to each other to form a closed shell. Welding can also be expanded between the all boundaries which part 83 is in contact to further enhance the structural integrity of the assembly 80.

FIG. 11 presents the cross section of the five layer composite 80 presented in exploded form in FIG. 10. In this illustration the contact areas are shown and it shows how they come in contact to each other forming a single solid material to satisfy the design goals.

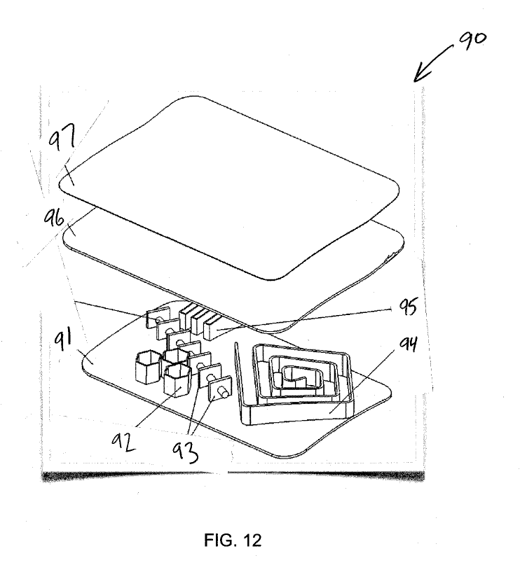

FIG. 12 is general format of an exemplary welded structure 90. Part 91 is the main structure with special rib structures including 92 (honeycomb or polygonal), 93 (rod and block), 94 (serpentine) and 95 (hollow block). Rib structures are added for various reasons like sound isolation, thermal insulation, impact resistance, fracture redirection, resonance frequency, or support for extra elements in the unit like holding part number 96. The structure of the ribs is opaque to laser light and absorbs the energy on the surface that comes in contact with part 96. Part 97 is the closing shell and is designed to pass the laser light. This combination enables laser welding of two parts 91 and 96. After welding the first two parts, to create a more robust product, extra layers can be added. There are several options. As mentioned in laser welding processes the first layer that light passes through should generally be transparent to the laser beam and the next layer should generally be opaque. It is very straight forward to attach another laser transparent part to the other side of the part 91. However, adding another layer on top of the part 97 is not generally as straightforward.

There are, however, several techniques to make the part 97 a blend of the transparent/opaque part to use it as a middle layer. In general a middle layer should be a blend of the laser transparent/opaque polymer in order to be weld-able to pre/post layers. Such a layer can be produced using different techniques such as: two shot molding, laser welding of the two parts, coating of the part with another polymer, or any other technique to make the part transparent in some areas and opaque on other sections. This will enable addition of more layers to the assembly. Final product will be a series of layers with different structural ribs all welded to each other using laser beam, usually a diode type laser which is fairly popular in welding of the polymers.

The following table sets forth various design parameters and manufacturing methods are summarized in accordance with the present disclosure.

| Design Parameter | Design Technique | Detail Design | Manufacturing |
|---|---|---|---|
| Environmental | Closed shell design | Closed shell design | Injection molding of |
| protection | for maximum | for maximum | the parts with |
| | protection. This will | protection. This will | matching surfaces. |
| | limit the exposure of | limit the exposure of | Parts can be clamped |
| | inside parts to | inside parts to | and laser welded to |
| | environment. Some | environment. Some | form the closed shell |
| | areas of the | areas of the | for maximum |
| | assembly can have | assembly can have | protection |
| | this feature | this feature. | |
| Impact | Multi layer design | High density ribs to | Injection molding of |
| Protection | with high density | distribute the load | the parts with high |
| | ribs in the impact | into a wide area. | density ribs, matching |
| | areas. | Multi layer design | surfaces. Parts can be |
| | | for maximum | clamped and laser |
| | | impact resistance. | welded to form the |
| | | | assembly. |
| Thermal | Maximum thermal | Closed shell design | Injection molding of |
| Insulation | insulation in critical | to act as cavities to | the parts with special |
| | areas by using | hold air/insulation as | cavities formed to |
| | vacuum, insulation | a thermal insulator. | house insulating |
| | materials and/or | In more extreme | material. For more |
| | gasses. | case a vacuum but | extreme cases, |
| | | be defined inside the | assembly can be |
| | | closed shell for | welded under vacuum |
| | | maximum thermal | or cavity's trap air can |
| | | insulation. | be removed to form a |
| | | Meanwhile adding | vacuum for maximum |
| | | extra stiffness to the | thermal insulation. |
| | | assembly. | |
| Acoustic | Maximum acoustic | Closed shell design | Injection molding of |
| Insulation | insulation in critical | to act as cavities to | the parts with special |
| | areas by using | hold air/insulation as | cavities formed to |
| | vacuum, acoustic | a acoustic insulator. | house insulating |
| | insulation materials. | In more extreme | material. For more |
| | | case a vacuum but | extreme cases, |
| | | be defined inside the | assembly can be |
| | | closed shell for | welded under vacuum |
| | | maximum acoustic | or cavity's trap air can |
| | | insulation. | be removed to form a |
| | | Meanwhile adding | vacuum for maximum |
| | | extra stiffness to the | acoustic insulation. |
| | | assembly. | |
| Thermal | Maximum heat | Special duct/fin | Injection molding of |
| Management | transfer for critical | design to direct the | the parts with special |
| | areas to keep the | fluid (liquid/gel/gas) | fin/ducts molded into |
| | temperature under | to the specific areas | the parts. Laser |
| | control. | to keep the | welding of the |
| | | temperature under | assemblies to further |
| | | control. Laser | enhance the heat |
| | | welding of the | transfer. Possible |
| | | design for perfect | metal coating of the |
| | | material contact. | assembly to maximize |
| | | Meanwhile adding | the heat transfer rate. |
| | | extra stiffness to the | |
| | | assembly. | |
| Aerodynamic | Generate proper air | Design of the fluid | Injection molding of |
| Performance | flow pattern in the | flow pattern | the parts with special |
| | product to achieve | connected to the | fluid flow surfaces |
| | drag/lift/turbulence. | supporting ribs to | and supporting ribs, |
| | | achieve load transfer | and laser welding of |
| | | with minimal | the components. |
| | | deformation. At the | |
| | | same time reducing | |
| | | the weight and | |
| | | providing optimum | |
| | | stiffness to weight | |
| | | ratio. | |
| Weight | To achieve certain | Create required level | Injection molding of |
| Reduction | stiffness with | of stiffness on the | the parts with |
| | minimum added | critical areas using | designed features. |
| | weight. | layers of laser | Laser welding of the |
| | | welded ribs/surfaces | layers with extra |
| | | to minimize added | processes as needed |
| | | weight without | (special coatings) to |
| | | sacrificing the | achieve defined |
| | | mechanical | design characteristics. |
| | | properties. | |
| Enhanced | Reduce weight and | Create required level | Injection molding of |
| Resonance | increase mechanical | of stiffness on the | the parts with |
| Frequency | stiffness to increase | critical areas using | designed features. |
| | the resonance | layers of laser | Laser welding of the |
| | frequency of the | welded ribs/surfaces | layers with extra |
| | product. Or just | to minimize added | processes as needed |
| | simply shift the | weight without | (special coatings) to |
| | frequency in some | sacrificing the | achieve defined |
| | areas without any | mechanical | design characteristics. |
| | effect on the | properties. This will | |
| | mechanical | increase the | |
| | properties. | resonance | |
| | | frequency. For a | |
| | | small change into | |
| | | the resonance | |
| | | frequency, simply | |
| | | change the rib | |
| | | density/pattern in | |
| | | some areas. | |
| Defined | Product designed to | Create desired level | Injection molding of |
| Fracture Path | fail along a defined | of stiffness on the | the parts with |
| | path when load | critical areas using | designed features. |
| | carrying limit is | layers of laser | Laser welding of the |
| | reached. | welded ribs/surfaces | layers with extra |
| | | to minimize added | processes as needed |
| | | weight without | (special coatings) to |
| | | sacrificing the | achieve defined |
| | | mechanical | design characteristics. |
| | | properties. Change | |
| | | the ribbing density | |
| | | along a path which | |
| | | is desired to fail to | |
| | | fracture when load | |
| | | carrying limit is | |
| | | reached. | |
| Low | Minimize the | Ribs and surface | Simple design leads to |
| Production | amount of material | thicknesses can be | low cost tooling, and |
| Cost | used and avoid | optimized for load | lower cost fixtures for |
| | using any extra | carrying capability. | laser welding station |
| | complexity in the | Keep the geometry | reducing the capital |
| | parts. | simple for tooling | cost for NRE/tooling |
| | | and plan to use laser | and later production |
| | | energy to bond the | cost per unit. In |
| | | parts to form the | addition all the |
| | | final product and | processes can use |
| | | achieve proper level | conventional |
| | | of mechanical | production |
| | | performance. | equipments that are |
| | | | commercially |
| | | | available. Material |
| | | | usage is also |
| | | | optimized, leading to |
| | | | lower cost. |
| Low Tooling | Use of simple part | Possibility to design | Simplified tooling, |
| Cost | geometry is possible | parts that require | reduces the tooling |
| | as all of the parts | simple mold | design/manufacturing |
| | have simple shape | configuration. This | cost and leads to |
| | and very easy for | will accelerate | lower NRE. |
| | tooling | development time in | |
| | design/manufacture | design, reducing the | |
| | | cost. | |
| Recyclable | Use of recyclable | Use engineering | %100 recyclable |
| | materials that can be | polymers, and | product, that can be |
| | recycled in the | recycle them as | recycled in the |
| | production line | needed in the | production shop floor |
| | without any need to | design. This will | is highly attractive and |
| | special recycling | reduce the | reduces the product |
| | facilities. | production cost (in | carbon foot print |
| | | case of production | considering low |
| | | error) and overall | energy levels required |
| | | cost of the raw | for recycling. |
| | | material. Low | |
| | | energy needed to | |
| | | recycle the parts | |
| | | contributes to the | |
| | | efficiency of the | |
| | | technique | |
| Short | Total flexibility in | Possibility of | As product takes |
| Development | design and | creating any | shape in |
| Cycle | development | geometry with said | manufacturing, simple |
| | decreases the design | technique will | layers get built with |
| | cycle time. | reduce the | ease and joined by |
| | | development cycle | laser to form the |
| | | significantly. | complex parts. This |
| | | Designer is flexible | leads to quick |
| | | to design very | manufacturing, |
| | | complex parts | reducing the overall |
| | | without being | development time. |
| | | worried of | |
| | | manufacturing | |
| | | issues | |

What is claimed is:

1. An assembly comprising:
a first component having a first side and a second side opposite the first side, the first side having at least one bonding structure extending therefrom and spaced from an outer perimeter of the first component; and
a second component having a first side and a second side opposite the first side, the second component thermally bonded to the first component along at least one interior interface including said bonding structure, said interface fully enclosed between the first and second components;
wherein at least a portion of at least one of the first or second components is laser transparent to allow passage of laser energy through said laser transparent portion to a laser opaque portion of the interface, said laser opaque portion configured to absorb laser energy to facilitate bonding.

2. An assembly as set forth in claim 1, wherein the at least one interface comprises a plurality of bonding structures extending from at least one of the first or second components.

3. An assembly as set forth in claim 2, wherein the at least one interface is between adjacent bonding structures extending respectively from the first and second components.

4. An assembly as set forth in claim 2, wherein the plurality of bonding structures includes one or more ribs having a shape.

5. An assembly as set forth in claim 3, wherein the shape includes at least one of a straight shape, a curved shaped, a closed shape, a honeycomb shape, a diamond shape, or a rectangular shape.

6. An assembly as set forth in claim 1, wherein at least one of the first or second components is comprised of a material including at least one of thermoplastic polymers or fiber reinforced thermoplastic polymers.

7. An assembly as set forth in claim 1 wherein at least one of the first or second components is comprised of a material including at least one of the polymers PA, PPA, PBT, a thermoplastic, or a thermoplastic elastomeric polymers.

8. An assembly comprising a first part and a second part bonded to the first part, the assembly having an interior chamber and an exterior shell surrounding said chamber, the first part and second part being bonded together along an interface within said chamber, a portion of the exterior shell being laser transparent, and the interface being formed between a laser transparent part of the first part and a laser opaque portion of the second part.

9. An assembly as set forth in claim 8, wherein the interface comprises a plurality of bonding structures extending from at least one of the first or second components.

10. An assembly as set forth in claim 9, wherein the plurality of bonding structures includes one or more ribs having a shape.

11. An assembly as set forth in claim 10, wherein the shape includes at least one of a straight shape, a curved shaped, a closed shape, a honeycomb shape, a diamond shape, or a rectangular shape.

12. An assembly as set forth in claim 8, wherein at least one of the first or second components is comprised of a material including at least one of thermoplastic polymers or fiber reinforced thermoplastic polymers.

13. An assembly as set forth in claim 8 wherein at least one of the first or second components is comprised of a material including at least one of the polymers PA, PPA, PBT, a thermoplastic, or a thermoplastic elastomeric polymers.

14. A method of making an assembly having at least two components bonded together comprising the steps of:
placing a first component in contact with a second component to form an interface, the first component having a first side and a second side opposite the first side, the first side having at least one bonding structure extending therefrom and spaced from an outer perimeter of the first component; and
securing the first component to the second component along an interface including the bonding structure, said interface fully enclosed between the first and second components;
wherein the securing includes passing a laser through a laser transparent portion of at least one of the first or second components to a laser opaque portion of at least one of the first or second components, whereby laser energy passing through the laser transparent portion and absorbed by the laser opaque portion heats the laser opaque portion to weld the first and second components together along an interface therebetween.

15. A method as set forth in claim 14, further comprising forming the first component having the bonding structure, wherein the forming includes selecting at least one design parameter, and determining at least one of a dimension of the first component, or a location or a dimension of the at least one bonding structure based at least in part on the selected design parameter.

16. A method as set forth in claim 15, wherein selecting the at least one design parameter includes selecting at least one of the following design parameters: environmental protection, impact protection, thermal insulation, acoustic insulation, thermal management, aerodynamic performance, weight reduction, enhanced resonance frequency, defined fracture path, low production cost, low tooling cost, recyclable, and/or short development cycle.

17. A product produced by the process set forth in claim 14.
